(19) United States
(12) Patent Application Publication
(10) Pub. No.: US 2011/0133528 A1
(43) Pub. Date: Jun. 9, 2011

(54) Buckles away

(76) Inventors: Cristina Francesca Keith, Playa Del Rey, CA (US); Jennifer Ann Hartman, Los Feliz, CA (US); Philip Bentley Kirst, Hawthorne, CA (US)

(21) Appl. No.: 12/802,027

(22) Filed: May 28, 2010

Related U.S. Application Data
(60) Provisional application No. 61/283,681, filed on Dec. 8, 2009.

(51) Int. Cl. B60N 2/28; B60R 22/12

(52) U.S. Cl. 297/216.11; 297/483

(57) ABSTRACT

Strap with one magnetic end to maintain harness strap and male buckle component of child seat in open position. The strap facilitates the ease of placement and removal of the child from the car seat by maintaining harness in open (retracted) position, eliminating the interference of the restraint straps when placing the child in the car seat.

### CROSS REFERENCE TO RELATED APPLICATION

This patent application claims the benefits and privileges of provisional patent application No. 61/283,681, filed on Dec. 8, 2009, confirmation No. 6022.

### FIELD OF INVENTION

This invention relates to car seats. More specifically, it relates to a strap that will be used in conjunction with the seatbelt restraint system of the car seat.

### BACKGROUND OF INVENTION

Car seats with a seatbelt restraint system are mandated for infants and children in under the laws of all 50 states. The car seat is especially designed to protect infants and children in case of a collision. There is also the need to make the car seat more functional and more comfortable, while maintaining the safety of the car seat.

Currently, there are no devices that address a problem universal to all infant car seats, the lack of any means of holding the harness straps in an open position to allow for safer and easier insertion and removal of the child from the car seat.

With the current design, a parent or care giver, in the act of placing an infant or child into a car seat, must first place the child in the seat on top of the harness and then reach behind the infant to pull around the infant the straps of the harness with its sharp metal and plastic buckle components out from behind the child. Frequently, the infant or child is made uncomfortable by the maneuvering of the components from behind his or her back.

This invention eliminates the aforementioned problem by providing the strap mechanism that maintains the restraint harness in an open position prior to the insertion of the infant or child and does not require the use of hands by parent or care giver to maintain the harness in open position.

### SUMMARY OF INVENTION

This invention relates to the seatbelt restraint system of an infant or child car seat. Comprised of a strap that is attached by a snap to the handle of the car seat. The strap contains an elasticized portion to allow an appropriate fit for all styles and sizes of car seats. The strap further contains a magnet housed at one end of the strap. When the strap is attached to the handle, the magnetized end securely holds the male buckle component of the corresponding harness strap up and away from the car seat bucket where the infant or child is placed prior to securing the harness. When the infant or child has been placed in the bucket of the car seat the parent can easily disengage the harness from the magnetized strap and secure the infant or child.

### DETAILED DESCRIPTION OF DRAWINGS

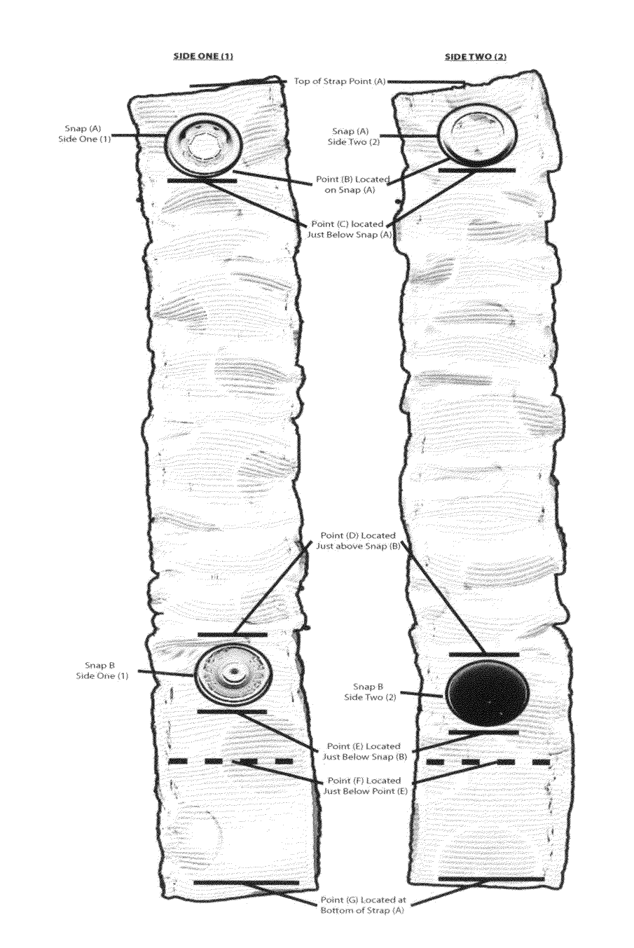

FIG. 1 depicts Side One of the strap from point A (the top of the strap) to point B, will contain a top snap, Snap A. Where Snap A, the female snap, is positioned on side one.

FIG. 1 from point C to point D depicts the elasticized portion of the strap of sufficient length to allow strap to fit around child car seat handles.

FIG. 1 from point D to point E of Side One of the strap contains a male snap, Snap B. Where Snap B the male snap, is positioned on Side One.

FIG. 1 from point F to point G of the strap is the portion of the strap which houses the magnet. This portion of the strap will contain the magnet corresponding and attracting the male buckle of the safety harness. Thus holding the shoulder straps up and away from the back of the child seat.

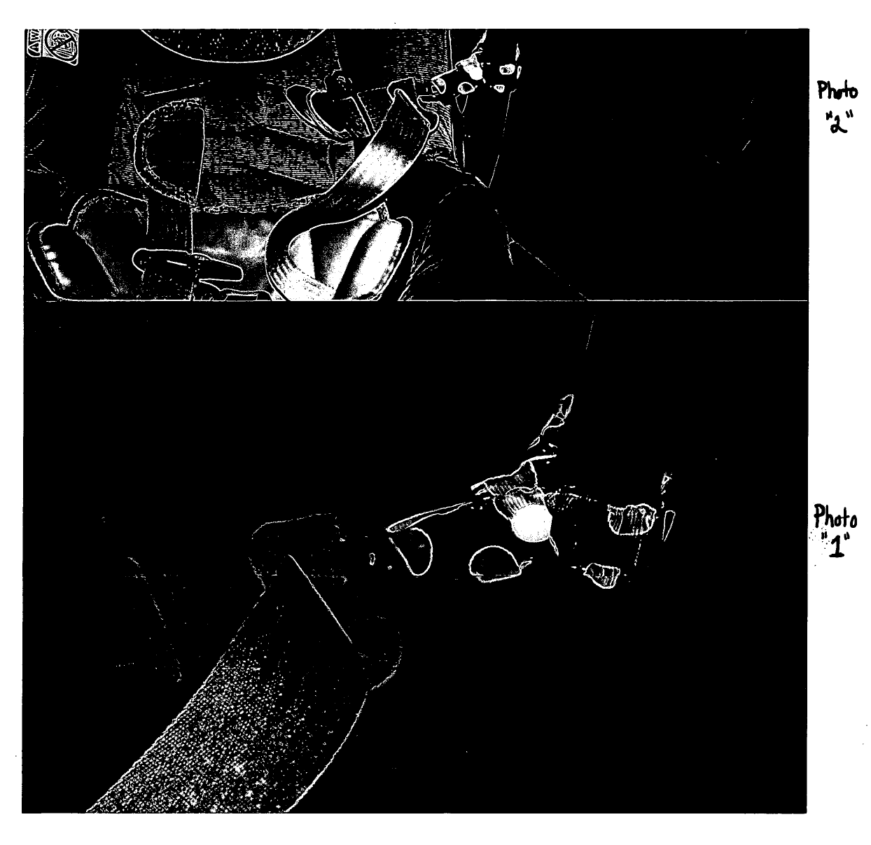

FIG. 2 represents the back of Side 1, Side 2. Side 2 between point A and point B is where the back of snap A is located.

FIG. 2, Side 2, between point D and point E is where the back of Snap B is located.

### DETAILED DESCRIPTION OF PREFERRED EMBODIMENT

As seen in Photo 1, the strap as described in claim 1 is attached to the handle of the car seat by the elasticized portion of the strap, claim 4, secured by means of the snap described in claim 2.

The strap so positioned allows the magnet contained therein, as described in claim 3 to attract the male buckle component of the harness housed in the car seat.

As seen in photo 2 the strap is holding the harness in an open position to allow for convenient placement and removal of the infant from the car seat.

What is claimed is:

1. An (elasticized) strap with a magnetized end to hold the male buckle component of the harness of any child restraint system (car seat) in an open position, said strap comprising: a strap adapted to attach to handle of any (independent) child restraint system such that the male buckle component of said restraint system can be maintained in open (retracted) position, as a result of the attracting polarity provided by the magnet housed in the strap and the attractive properties of the steel buckle.

2. The (elasticized) strap as set forth in claim 1, comprises at least one snap for attaching said strap to the handle of any child restraint system, whether said handle is in the recumbent position for vehicular travel or extended over the carrier for manual transport of the child.

3. The strap as described in claim 2, further houses a magnet of sufficient strength to attract the male buckle component of the corresponding harness strap.

4. The strap as described in claim 3, wherein said strap includes an elasticized portion to allow the strap to accommodate the full range of sizes and shapes of car seat handles.

5. A child restraint system (car seat) comprising: a seatbelt restraint housed in an independent seat with handle, removable in its entirety from the vehicle, adapted to be secured to a seat inside a vehicle, to which said strap is attached with the snap referenced in claim 2 to the handle to fix the strap to the restraint system, whereby said strap extends into the independent seat a sufficient amount to allow for the magnet described in claim 3 to exert its polarity to attract the male buckle component of the restraint thereby keeping the harness in open position.
